(19) United States
(12) Patent Application Publication
(10) Pub. No.: US 2006/0078269 A1
(43) Pub. Date: Apr. 13, 2006

(54) Video optical receiver

(75) Inventor: Jae-Myung Baek, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/111,632

(22) Filed: Apr. 21, 2005

(30) Foreign Application Priority Data
Oct. 8, 2004 (KR) 2004-80195

(51) Int. Cl. G02B 6/00

(52) U.S. Cl. 385/147

(57) ABSTRACT

A video overlay optical receiver is disclosed. The receiver includes a light-receiving device arranged to convert an optical signal into an electrical signal and a transimpedance amplifier having an output impedance value of 50Ω for amplifying the electrical signal.

### CLAIM OF PRIORITY

This application claims priority to an application entitled “Video Overlay Optical Receiver,” filed in the Korean Intellectual Property Office on Oct. 8, 2004 and assigned Serial No. 2004-80195, the contents of which are incorporated herein by reference.

### BACKGROUND OF THE INVENTION

1. Field of the Invention

The present invention relates to an optical receiver, and more particularly to a video overlay optical receiver for receiving an image signal.

2. Description of the Related Art

Passive optical networks (‘PON’) that include optical transceiver modules of 1.25 Gbps are known. Such optical transceiver modules have a package type in which an optical transmission means and an optical reception means are integrated. This enables bidirectional transmission/reception.

The aforementioned PON uses a wavelength band of 1310 nm as the wavelength band of an uplink optical signal and a wavelength band of 1490 nm as the wavelength band of a downlink optical signal for bidirectional communication. A PON using a wavelength band of 1550 nm or 1558 nm is also known. Such a PON can provide wired broadcasting to a home.

Subscribers connected to a PON must install a video overlay optical receiver in order to receive wired broadcasting and satellite broadcasting transmitted through optical signals. A general video overlay optical receiver includes a photodiode for converting an optical signal into an electrical signal. The optical signal received in the video overlay optical receiver is converted into the electrical signal and is then transmitted to a wideband optical amplifier having an input and output impedance value of 75Ω for cable broadcasting.

The photodiode has an internal impedance much higher than the wideband optical amplifier. Therefore, the electrical signal converted from the optical signal by the photodiode is frequently reflected in the wideband optical amplifier due to difference of impedance between the wideband optical amplifier and the photodiode. The impedance difference between the wideband optical amplifier and the photodiode causes signal distortion and loss.

In order to solve the problems as described above, a method of inserting a matching resistor having an impedance value of 75Ω between the photodiode and the wideband optical amplifier has been used. However, an optical receiver including such a matching resistor has bad noise characteristics.

A structure including an impedance transformer for improving the aforementioned noise characteristics is disclosed in U.S. Pat. No. 6,410,902. In addition, a structure including a Balun (Balance to unbalanced transformer) for improving linearity characteristic is disclosed in U.S. Pat. No. 6,741,814.

However, the impedance transformer transforms a high impedance value of the electrical signal converted by the photodiode to an impedance value of 75Ω of the wideband optical amplifier, so that the ratio of impedance transformation increases. However, since the available bandwidth narrows, the optical receiver cannot be used in a wide frequency band of more than 2 GHz.

### SUMMARY OF THE INVENTION

One aspect of the present invention relates to a video overlay optical receiver which uses a wide frequency band and has superior noise characteristics.

One embodiment of the present invention is directed to a video overlay optical receiver including a light-receiving device for converting an optical signal into an electrical signal and a transimpedance amplifier having an output impedance value of 50Ω for amplifying the electrical signal.

### BRIEF DESCRIPTION OF THE DRAWINGS

The above and other aspects, features and embodiment of the present invention will be more apparent from the following detailed description taken in conjunction with the accompanying drawings, in which:

FIG. 1 is a block diagram showing a video overlay optical receiver according to a first embodiment of the present invention;

FIG. 2 is a graph illustrating the characteristics of the transimpedance amplifier shown in FIG. 1;

FIG. 3 is a graph illustrating the bandwidth characteristics of the video overlay optical receiver shown in FIG. 1;

FIG. 4 is a graph illustrating power distribution of an optical signal when a plurality of channels are simultaneously applied to a video overlay optical receiver;

FIG. 5 is a block diagram showing a video overlay optical receiver according to a second embodiment of the present invention;

FIG. 6 is a block diagram showing a video overlay optical receiver according to a third embodiment of the present invention; and

FIG. 7 is a block diagram showing a video overlay optical receiver according to a fourth embodiment of the present invention.

### DETAILED DESCRIPTION

Hereinafter, embodiments according to the present invention will be described with reference to the accompanying drawings. For the purposes of clarity and simplicity, a detailed description of known functions and configuration incorporated herein will be omitted as it may obscure the subject matter of the present invention.

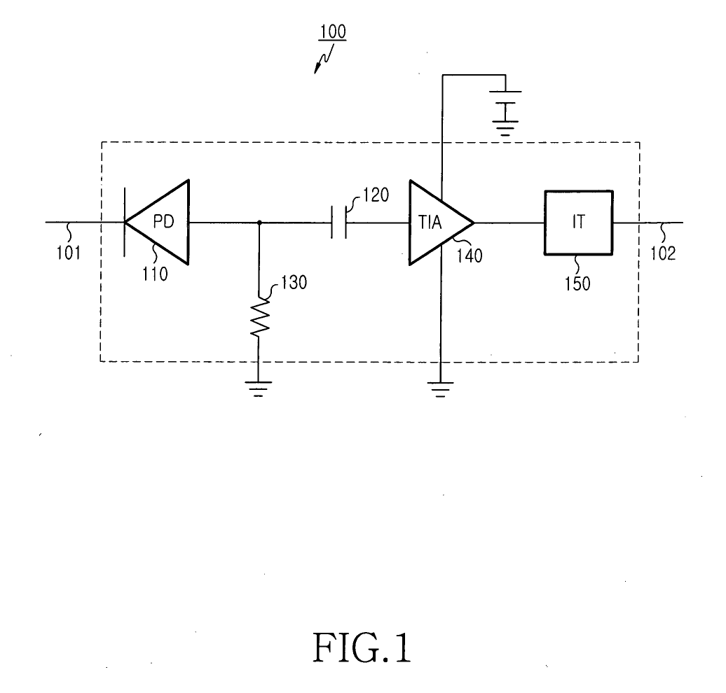

FIG. 1 is a block diagram showing the structure of a video overlay optical receiver 100 according to a first embodiment of the present invention. The video overlay optical receiver 100 includes a light-receiving device 110 for converting an optical signal into an electrical signal, a transimpedance amplifier (TIA) 140 having an output impedance value of 50Ω in order to amplify the electrical signal, and an impedance transformer (IT) 150 for performing impedance transformation for the electrical signal amplified by the transimpedance amplifier 140 so as to have an output impedance value of 75Ω. The receiver 100 also includes a resistor 130 for grounding direct current (DC), and a blocking capacitor 120. The transimpedance amplifier 140 has a frequency bandwidth of more than 870 MHz for reception of a cable broadcasting (CATV) and must have a frequency bandwidth of 2.15 GHz for reception of terrestrial broadcasting (MATV) and satellite broadcasting (SATV). The video overlay optical receiver 100 converts the optical signal input to an input side 101 into the electrical signal having an output impedance value of 75Ω and outputs the electrical signal to an output side 102.

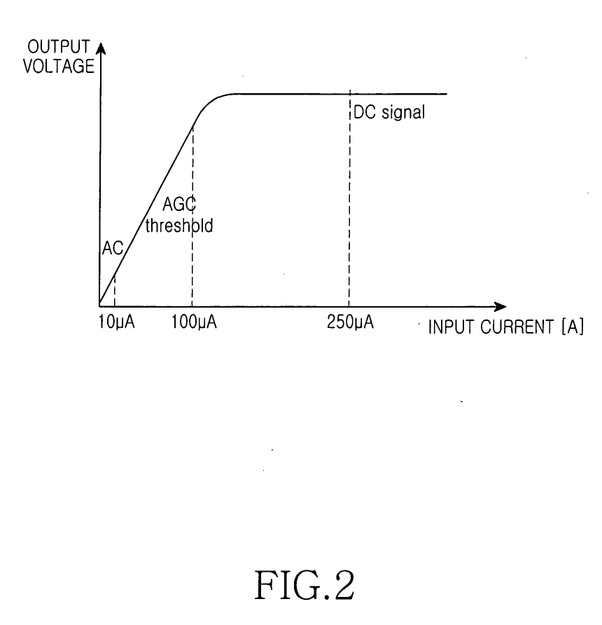

The transimpedance amplifier 140 has an automatic gain control (‘AGC’) function to prevent overload from occurring. FIG. 2 shows a graph illustrating the characteristics of the transimpedance amplifier 140 shown in FIG. 1. When input electric current has an amplitude below a critical value (100 μA), the transimpedance amplifier 140 has a transimpedance (dVo/dli) of a high constant value. In contrast, when electric current having an amplitude exceeding the critical value is input, the intensity of an electrical signal output from the transimpedance amplifier 140 always has a constant value or very small transimpedance value. The transimpedance amplifier 140 has a degraded linearity when electric current above the critical current is input.

The resistor 130 grounds only a direct current component of the electrical signal converted by the light-receiving device 110 to prevent the direct current component from deteriorating the characteristics of the electrical signal. The resistor 130 is set to have several kΩ to minimize heat noise due to the resistor 130 and prevent gain property of the transimpedance amplifier 140 from being deteriorated. In an optical signal for wired broadcasting, a small signal (˜10 μW) is carried by large direct current (−6 dBm=250 μW) every channel, so that the direct current component must be eliminated from the electrical signal converted by the light-receiving device 110.

When the ratio (responsivity) of current output with respect to an optical input in the light-receiving device 110 is 1 (A/W), the blocking capacitor 120 sends an electrical signal remaining except for direct current (250 μA) grounded in the resistor 130 to the transimpedance amplifier 140. The transimpedance amplifier 140 then amplifies the input electrical signal.

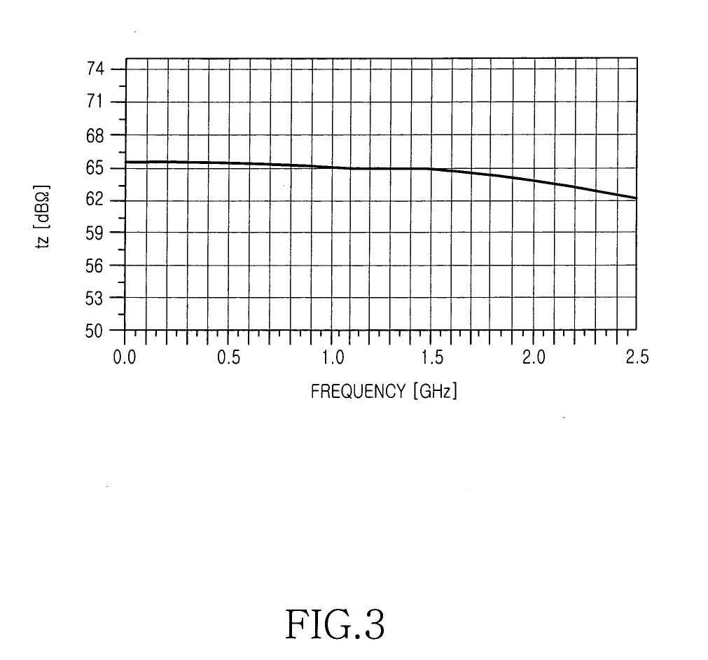

FIG. 3 is a graph illustrating the bandwidth characteristics of the video overlay optical receiver shown in FIG. 1. The graph shown in FIG. 3 is obtained through simulation using an equivalent model of the light-receiving device and an S-parameter measured in the transimpedance amplifier 140. In the graph, the video overlay optical receiver 100 has a bandwidth of 2.48 GHz.

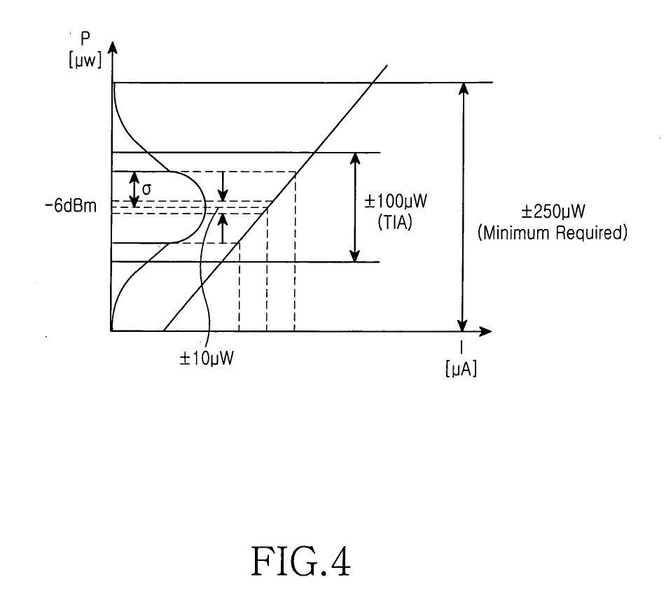

FIG. 4 is a graph illustrating power distribution of the optical signal input to the video overlay optical receiver. According to the ITUT-G 983.3 optical communication standard, in a sub-carrier multiplexing (SCM) optical transmission system of a carrier format of an AM-VSB (analog broadcasting), an optical receiver has a minimum input power of −6.7˜7.7 dBm. In the graph of FIG. 4, when a signal having the maximum number of channels is contained in an input optical signal having an average power of −6 dBm (250 μW) and input to the optical receiver, an entire optical power has a Gaussian distribution with respect to −6 dBm according to time. An optical signal having a power of 0˜500 μW may be input to the video overlay optical receiver. When the ratio (responsivity) of current output with respect to an optical input in the light-receiving device 110 is 1 (A/W), electric current of 0˜500 μA is input to the transimpedance amplifier 140. A transimpedance amplifier capable of receiving an optical signal having an amplitude of 100 μA without distortion is sufficient for a general video overlay optical receiver having a limited number of channels. However, in order to accommodate various broadcast media such as channels of terrestrial broadcasting, wired cable broadcasting and satellite broadcasting, the video overlay optical receiver must maintain the maximum number of channels and have a bandwidth range of 50˜2150 MHz. In order to ensure the maximum number of channels as described above, the transimpedance amplifier must maintain linearity with respect to an optical signal having an amplitude of 250 μA.

Consequently, in order to receive various types of broadcasting signals, the transimpedance amplifier must ensure linearity even for an optical signal having an intensity of 250 μA. In order to ensure the linearity for the optical signal having an intensity of 250 μA, it is possible to use a transimpedance amplifier having a transimpedance value determined based on a voltage applied from outside to a separate AGC terminal regardless of the power of the input optical signal.

In addition, for a transimpedance amplifier that does not have an AGC function, a constant impedance value (tz) may be used. Herein, a F0100408B, a F0100404B, etc., of a Eudyna Co., Ltd have been used as products which does not have the AGC function.

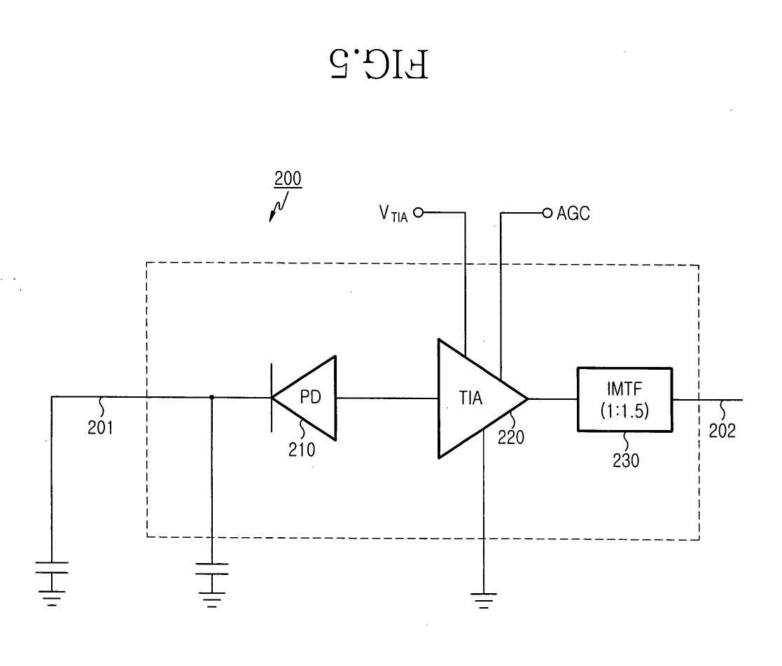

FIG. 5 is a block diagram showing the structure of a video overlay optical receiver 200 according to a second embodiment of the present invention. The video overlay optical receiver 200 includes a light-receiving device 210, a transimpedance amplifier 220 having an output impedance of 50Ω and an impedance transformer 230. The light-receiving device 210 is directly connected to the transimpedance amplifier 220 without using a separate DC blocking means such as a resistor, a blocking capacitor, etc. The impedance transformer 230 performs an impedance transformation for an input signal at the rate of 1:1.5 to allow the input signal to have an output impedance of 75Ω.

The transimpedance amplifier 220 may use a transimpedance amplifier having a separate AGC terminal V_{AGC}. When a voltage is applied to the AGC terminal V_{AGC}, the transimpedance amplifier 220 stops an AGC function and has a predetermined transimpedance value (tz) according to the applied voltage. The transimpedance amplifier having the separate AGC terminal may include an M02016, M02013, etc., of Mindspeed electric Co., Ltd and TZA3043BU, etc., of Philips Co., Ltd.

Meanwhile, since a digital broadcasting signal has an alleviated standard (QPSK:16 dB, 16-QAM:22 dB, 64-QAM:34 dB) of a carrier-to-noise ratio (CNR) as compared with an analog broadcasting signal (AM-VSB:44 dB), an input DC level (minimum required power level, QPSK:−18.3 dB, 64-QAM:−13.6 dB, 256-QAM:−10.5 dB) of a receiver can be lowered below −10 dBm. In such a case, it is possible to use a transimpedance amplifier having a high threshold current (100 μA) of an AGC. When analog broadcasting is ended and every broadcasting changes into digital broadcasting, it is possible to accommodate the maximum number of channels according to the first embodiment of the present invention. Further, in the second embodiment of the present invention, even though the transimpedance amplifier is replaced with an amplifier having a general AGC function, it is possible to accommodate the maximum number of channels.

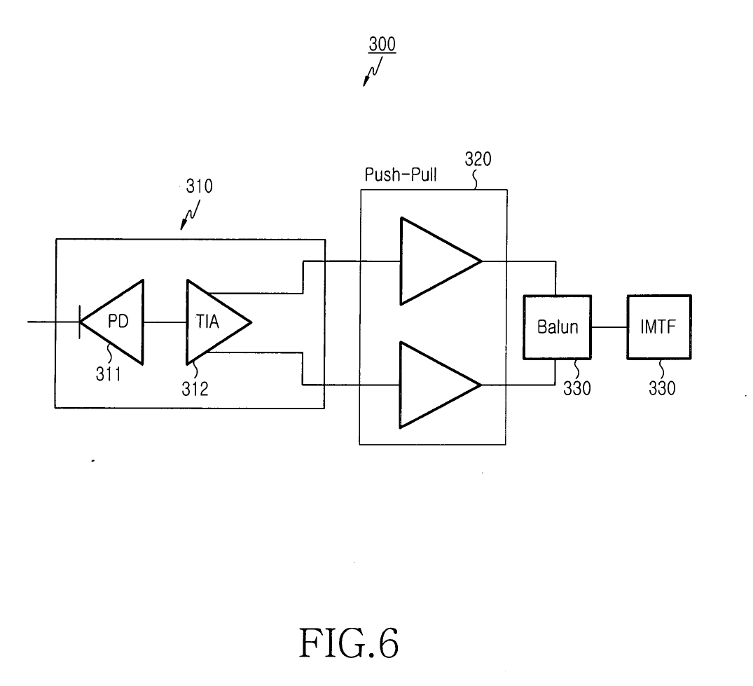

FIG. 6 is a block diagram showing the structure of a video overlay optical receiver 300 according to a third embodiment of the present invention. The video overlay optical receiver 300 includes an initial stage optical receiving unit 310, a push-pull 320 connected to the initial stage optical receiving unit 310, a Balun 330 connected to the push-pull 320 and an impedance transformer 340 connected to the Balun 330.

The initial stage optical receiving unit 310 includes a light-receiving device 311 and a transimpedance amplifier 312. The light-receiving device 311 converts a received optical signal into an electrical signal and outputs the electrical signal to the transimpedance amplifier 312. The transimpedance amplifier 312 differentially amplifies the electrical signal and outputs the amplified electrical signal to the push-pull 320 having an input impedance of 50Ω.

The Balun 330 incorporates the electrical signals differentially amplified in the push-pull 320 into one electrical signal and outputs the incorporated electrical signal to the impedance transformer 340. The impedance transformer 340 has an impedance transformation rate of 1:1.5 and performs an impedance transformation for the electrical signal output from the Balun 330 to allow the electrical signal to have an impedance value of 75Ω. Meanwhile, when the transimpedance amplifier 312 has a sufficient gain, the operation of the push-pull 320 may be omitted. Further, when the Balun 330 transforms impedance by itself, the operation of the impedance transformer 340 may also be omitted.

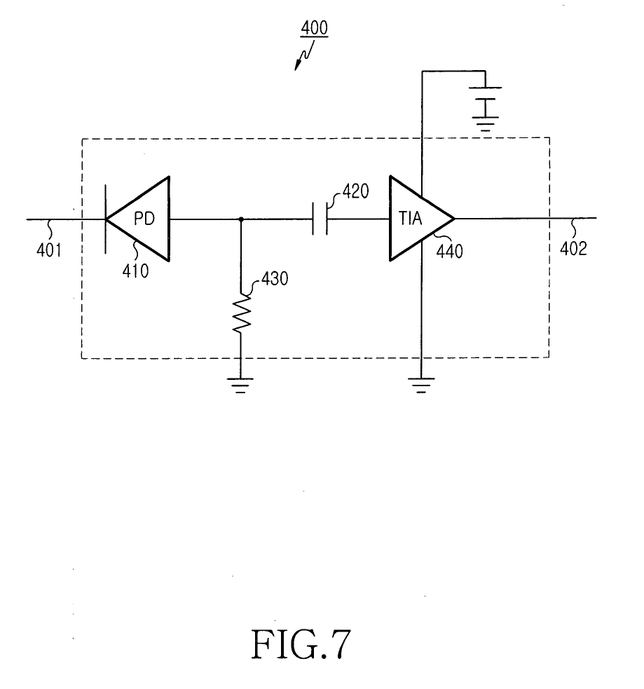

FIG. 7 is a block diagram showing the structure of a video overlay optical receiver 400 according to a fourth embodiment of the present invention. The video overlay optical receiver 400 includes a light-receiving device 410 for converting an optical signal into an electrical signal and a transimpedance amplifier 420. The light-receiving device 410 is directly connected to the transimpedance amplifier 420.

The transimpedance amplifier 420 amplifies the electrical signal to have an impedance value of 75Ω for use in data communication and outputs the amplified electrical signal.

The video overlay optical receiver 400 converts the optical signal input to an input side 401 into the electrical signal having the impedance value of 75Ω and outputs the amplified electrical signal through an output side 402.

The video overlay optical receiver 400 uses the transimpedance amplifier 420 having an output impedance of 75Ω for data communication, instead of a transimpedance amplifier having an output impedance of 50Ω. It is unnecessary to use an impedance transformer having an impedance transformation rate of 1:1.5.

As described above, a video overlay optical receiver can receive optical signals over a wide band of more than 2.0 GHz, minimize the noise of the received optical signals, and receive optical signals of high linearity.

Although embodiments of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A video overlay optical receiver comprising:
a light receiver arranged to convert an optical signal into an electrical signal; and
a transimpedance amplifier having an output impedance value of 50Ω arranged to amplify the electrical signal.

2. The video overlay optical receiver as claimed in claim 1, further comprising a impedance transformer arranged to impedance transformation the electrical signal of 50Ω input from the transimpedance amplifier at a rate of 1:1.5 and outputting an electrical signal of 75Ω.

3. The video overlay optical receiver as claimed in claim 1, wherein the light receiver includes a photodiode and is connected to the transimpedance amplifier.

4. The video overlay optical receiver as claimed in claim 1, wherein the transimpedance amplifier does not include an automatic gain control (AGC) function.

5. The video overlay optical receiver as claimed in claim 1, further comprising:
a resistor connected to a ground and the light receiver; and
a blocking capacitor connected between the light reciver and the transimpedance amplifier.

6. The video overlay optical receiver as claimed in claim 1, wherein the transimpedance amplifier includes an automatic gain control terminal for disabling an automatic gain control function of the transimpedance amplifier to be interrupted by an external operation.

7. A video overlay optical receiver comprising:
a light receiver arranged to convert an optical signal into an electrical signal; and a transimpedance amplifier coupled to the output of the light receiver, the transimpedance amplifier arranged to output an electrical signal to have an impedance value of 75Ω.

8. The video overlay optical receiver as claimed in claim 7, wherein the transimpedance amplifier does not include an automatic gain control (AGC) function.

9. The video overlay optical receiver as claimed in claim 7, wherein the transimpedance amplifier includes an automatic gain control terminal for stopping an automatic gain control function by an external input.

10. A video overlay optical receiver comprising:
a light receiver arranged to convert an optical signal into an electrical signal;
a transimpedance amplifier coupled to the output of the light receiver, the transimpedance amplifier differentially amplifying the electrical signal into two or more electrical signals having an output impedance of 50Ω and different polarities; and
a Balun arranged to generate an electrical signal not including signal distortion due to a secondary harmonic wave from the differentially amplified electrical signals.

11. The video overlay optical receiver as claimed in claim 10, further comprising a push-pull being disposed between the transimpedance amplifier and the Balun, the push-pull arranged to amplify the differentially amplified electrical signals and output the amplified electrical signals to the Balun.

12. The video overlay optical receiver as claimed in claim 10, wherein the video overlay optical receiver impedance transformations a corresponding electrical signal at a rate of 1:1.5.

13. The video overlay optical receiver as claimed in claim 10, wherein the light receiver includes a photodiode.
